(19) United States
(12) Patent Application Publication
(10) Pub. No.: US 2002/0188050 A1
(43) Pub. Date: Dec. 12, 2002

(54) Rubber composition for tire tread and pneumatic tire using the same

(76) Inventors: Noriko Yagi, Kobe-shi (JP); Kiyoshige Muraoka, Kobe-shi (JP)

Correspondence Address: BIRCH STEWART KOLASCH & BIRCH, PO BOX 747, FALLS CHURCH, VA, 22040-0747, US

(21) Appl. No.: 10/153,798

(22) Filed: May 24, 2002

(30) Foreign Application Priority Data
May 24, 2001 (JP) 2001-155667
Jun. 5, 2001 (JP) 2001-169703
Oct. 22, 2001 (JP) 2001-323879

(51) Int. Cl. C08K 3/26; C08K 3/04; C08K 3/34

(52) U.S. Cl. 524/425; 524/493; 524/496

(57) ABSTRACT

To provide a rubber composition for tire tread having remarkably improved wet grip performance without lowering abrasion resistance and rolling resistance property (low heat build-up characteristics), and a pneumatic tire using the same. The rubber composition for tire tread of the present invention comprises 5 to 150 parts by weight of calcium carbonate, at least 5 parts by weight of silica having nitrogen adsorption specific surface area of 100 to 300 m²/g and at least 1 part by weight of carbon black having nitrogen adsorption specific surface area of 70 to 300 m²/g based on 100 parts by weight of a rubber component, said rubber composition further comprising a silane coupling agent.

### BACKGROUND OF THE INVENTION

The present invention relates to a rubber composition for tire tread and a pneumatic tire using the same. More specifically, the present invention relates to a rubber composition for tire tread having remarkably improved grip performance on wet road while maintaining processability, abrasion resistance and fuel efficiency, and a pneumatic tire using the rubber composition for the tread part.

In recent years, a wide variety of properties such as steering stability, abrasion resistance, ride quality as well as fuel efficiency have been required for automobile tires and various ideas are suggested in order to improve these performances.

For example, it is tried to improve grip performance on road for the purpose of improving controllability and steering stability on wet road at high-speed running, or to improve cornering properties by increasing block rigidity of tire tread pattern and then preventing block deformation in case of cornering. It is also devised to inhibit deformation of groove so that excellent drainage is achieved to prevent hydroplaining.

Recently, grip performance on wet road is increased by compounding silica to a high styrene-content styrene-butadiene rubber (SBR) in order to meet the demand for such properties.

However, it is said that the above rubber composition for tire tread cannot exhibit sufficient grip performance on wet road or semi-wet road in high road temperature range of over 15° C., though the grip performance can be increased in low road temperature range of at most 15° C. Furthermore, it has been found that when running is carried on, the rubber composition containing silica shows decrease of rubber rigidity, resulting in remarkable decrease of grip performance. In addition, when dispersion of silica particles into rubber is insufficient, Mooney viscosity of the rubber composition is increased, causing problems that processability such as extrusion is poor.

In order to solve these problems, various suggestions have been made so far. For example, Japanese Unexamined Patent Publication Nos. 133375/1995 and 311245/1996 disclose a rubber composition obtained by compounding sintered clay to a diene rubber; and Japanese Unexamined Patent Publication No. 3373/1996 discloses a rubber composition obtained by compounding vulcanized rubber powder comprising a diene rubber and kaolinite to a particular diene rubber. It is now described that these rubber compositions have an effect on improvement of grip performance.

In addition, Japanese Unexamined Patent Publication Nos. 59893/1996 and 59894/1996 disclose a rubber composition obtained by compounding inorganic compound powder of a particular composition and carbon black to SBR containing a particular amount of styrene; and Japanese Unexamined Patent Publication Nos. 149954/1995 and 31250/1997 disclose a rubber composition obtained by compounding clay comprising kaolinite as a main component to a diene rubber whose rate of 1,2-bond in butadiene part is in a particular range. It is described that these rubber compositions also have a similar effect on improvement of grip performance.

However, at present, no rubber composition has yet been produced which has excellent wet grip performance while maintaining low heat build-up characteristics without lowering of abrasion resistance.

In addition, among the above properties, grip performance and rolling resistance property (fuel efficiency) in particular are properties related to hysteresis loss of a rubber. Generally, the larger the hysteresis loss is, the higher the grip performance is and the more improved the controllability is, but rolling resistance is increased at the same time, resulting in increase of fuel consumption.

In this way, grip performance and rolling resistance property are incompatible, and therefore various rubber compositions for tire are suggested in order to achieve both properties simultaneously. For example, since polymers and carbon black have a great influence on both properties in the rubber composition for tire, it is tried to improve both the rolling resistance property and the grip performance by suitably selecting the rate of combined styrene and the rate of 1,2-bond of butadiene part when a styrene-butadiene copolymer is used as a polymer. And in case of carbon black, the amount of carbon black is reduced or the particle diameter of carbon black is enlarged. In these methods, however, it is difficult to achieve compatibility between low heat build-up characteristics and reinforcing ability, and abrasion resistance. Accordingly, carbon black whose activity degree of particle surface is optimized is used at present.

On the other hand, there are many reports on the method of using silica and a silane coupling agent in order to achieve low heat build-up characteristics.

However, surface properties of inorganic compound powder such as silica have a great influence on rubber composition and often prevent the intended performance from being achieved to a remarkable degree. For example, since a silanol group, i.e., the surface functional group of silica forms a hydrogen bond, silica particles tend to coagulate with each other, causing problems such as lowering of mechanical strength and weakening of materials as well as remarkable decrease of workability.

In order to solve these problems, it has been tried to use various coupling agents, dispersion agents or surface modifiers. For example, it is considered that a sliane coupling agent combines to silanol group on the silica surface to prevent silica particles from coagulating with each other, resulting in improvement of processability. However, silane coupling agents are expensive, and can combine to some limited kinds of inorganic compounds such as silica, glass fiber and alumina owing to the characteristics of its functional group, and there has been a problem that the silane coupling agent is not effective for poorly reactive compounds such as titanium oxide, calcium carbonate, carbon black and graphite.

Other inexpensive dispersion agents and surface modifiers for inorganic compounds include an anionic, cationic or nonionic low molecular weight surfactant and fatty acid, but they have a problem that covering ability for inorganic compound is poor.

As mentioned above, the fact is that there is no rubber composition at present, which has improved dispersability of inorganic compound powder and excellent wet grip performance while maintaining abrasion resistance and low heat build-up characteristics without lowering of workability and processability.

### SUMMARY OF THE INVENTION

The present invention relates to a rubber composition for tire tread comprising,

5 to 150 parts by weight of calcium carbonate,

at least 5 parts by weight of silica having nitrogen adsorption specific surface area of 100 to 300 m²/g, and

at least 1 part by weight of carbon black having nitrogen adsorption specific surface area of 70 to 300 m²/g

based on 100 parts by weight of a rubber component,

said rubber composition further comprising a silane coupling agent.

It is preferable that the total amount of calcium carbonate, silica and carbon black is 50 to 150 parts by weight.

It is preferable that calcium carbonate has nitrogen adsorption specific surface area of at least 5 m²/g.

It is preferable that calcium carbonate has an average particle diameter of 0.01 to 50 μm.

It is preferable that the silane coupling agent is used in an amount of 1 to 20% by weight based on the weight of calcium carbonate and silica.

It is preferable that the silane coupling agent is one represented by the following formula (I):

(CₙH₂ₙ₊₁O)₃—Si—(CH₂)ₘ—Sₓ—(CH ₂)ₘ—Si—(OCₙH₂ₙ₊₁)₃ (I)

wherein n is an integer of 1 to 3, m is an integer of 1 to 4 and x is the number of sulfur atoms in the polysulfide part, an average of x being 2.1 to 4.

It is preferable that the rubber composition further comprises, based on the weight of calcium carbonate, 0.1 to 150% by weight of a polyether compound having a repeating unit represented by the following formula (II):

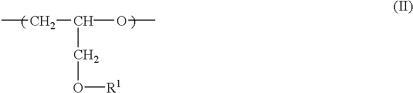

wherein R¹ is a hydrogen atom or a substituent selected from the group consisting of a hydrocarbon group having 1 to 50 carbon atoms, a siloxy silyl propyl group having 1 to 50 silicon atoms and a group represented by the formula —(AO)ₘ—R², and R¹ may be one kind or different kinds; and in the formula, R² is a hydrogen atom or a substituent selected from the group consisting of a hydrocarbon group having 1 to 42 carbon atoms and a siloxy silyl propyl group having 1 to 40 silicon atoms, A is an alkylene group having 2 to 3 carbon atoms, m is an integer of 1 to 100 and A, the number of which is represented by m, may be the same or different.

It is preferable that the rubber composition for tire tread is obtained by kneading the rubber component, calcium carbonate, silica, carbon black and silane coupling agent simultaneously at kneading temperature of 120° to 200° C.

The present invention also relates to a pneumatic tire obtained by using the rubber composition for tire tread.

### DETAILED DESCRIPTION

The present invention is explained in detail below.

The rubber component used in the present invention means a synthetic diene rubber or a mixed rubber comprising a synthetic diene rubber and a natural rubber. Examples of synthetic diene rubbers to be used in the present invention include styrene-butadiene rubber (SBR), butadiene rubber (BR), isoprene rubber (IR), ethylene-propylene-diene rubber (EPDM), chloroprene rubber (CR), acrylonitrile-butadiene rubber (NBR), butyl rubber (IR) and the like. The rubber may be used alone or in combination of two or more.

It is preferable that the rubber component contains at least 20% by weight of a styrene-butadiene rubber from the viewpoint of workability. The amount of the styrene-butadiene rubber in the rubber component is preferably 20 to 100% by weight, more preferably 30 to 100% by weight, most preferably 40 to 100% by weight. The amount of less than 20% by weight is not preferable since sufficient grip performance cannot be obtained. It is possible to use any styrene-butadiene rubber which is prepared by any polymerization method such as emulsion polymerization or solution polymerization.

The rubber composition of the present invention contains calcium carbonate. Preferable calcium carbonate is ultrafine calcium carbonate having nitrogen adsorption specific area (BET specific area) of at least 5 m²/g, preferably at least 10 m²/g. Calcium carbonate having nitrogen adsorption specific area of less than 5 m²/g is not preferable since there is a tendency that reinforcing ability cannot be exhibited sufficiently and abrasion resistance of the rubber composition is decreased. The nitrogen adsorption specific area is preferably at most 100 m²/g, more preferably at most 80 m²/g. When the nitrogen adsorption specific area is more than 100 m²/g, workability tends to decrease.

The amount of calcium carbonate is 5 to 150 parts by weight, preferably 10 to 120 parts by weight, more preferably 10 to 100 parts by weight, further preferably 10 to 80 parts by weight, particularly 10 to 65 parts by weight, especially 10 to 50 parts by weight, and most preferably 10 to 40 parts by weight based on 100 parts by weight of the rubber component. When the amount is less than 5 parts by weight, the improvement effect on wet grip performance tends to be small. When the amount is more than 150 parts by weight, the amount is not preferable since abrasion resistance tends to decrease.

The average particle diameter of calcium carbonate is preferably 0.01 to 50 μm, more preferably 0.01 to 10 μm, most preferably 0.02 to 8 μm. When the average particle diameter is less than 0.01 μm, workability tends to decrease. When the average particle diameter is more than 50 μm, reinforcing ability is lowered to deteriorate properties such as abrasion resistance.

Among the above calcium carbonates, activated calcium carbonate obtained by surface treatment using an organic material is preferable from the viewpoint of improving dispersability to the rubber. Organic materials used for the surface treatment are not particularly limited as long as they are generally used for surface treatment of calcium carbonate. Examples thereof include fatty acids, resin acids and surfactants.

The rubber composition of the present invention contains silica, and it is used to lower rolling resistance as well as to fill up the insufficient reinforcing ability in case of calcium carbonate. Silica used in the present invention has nitrogen adsorption specific area of 100 to 300 m²/g, preferably 130 to 280 m²/g, more preferably 150 to 250 m²/g. When the nitrogen adsorption specific area of silica is less than 100 m²/g, reinforcing ability tends to be smaller. When the nitrogen adsorption specific area of silica is more than 300 m²/g, such silica is not preferable since there is a tendency that dispersability is decreased to increase heat build-up characteristics of the rubber composition.

Examples of silica are not particularly limited, and they are suitably selected from dry method silica or wet method silica which have been conventionally used for the reinforcement of rubbers.

The amount of silica is preferably at least 5 parts by weight, more preferably at least 10 parts by weight, most preferably at least 15 parts by weight based on 100 parts by weight of the rubber component. When the amount of silica is less than 5 parts by weight, the amount is not preferable since there is a tendency that the reinforcing effect and the effect to lower the rolling resistance of the rubber composition cannot be obtained sufficiently. When the amount is more than 100 parts by weight, workability tends to decrease. For these reasons, the upper limit of the amount of silica is preferably at most 80 parts by weight, more preferably at most 75 parts by weight, further preferably at most 70 parts by weight and most preferably at most 65 parts by weight.

The rubber composition of the present invention contains carbon black. Carbon black used in the present invention has nitrogen adsorption specific area of 70 to 300 m²/g, preferably 90 to 280 m²/g, more preferably 90 to 250 m²/g, further preferably 100 to 250 m²/g, most preferably 100 to 230 m²/g. When carbon black has nitrogen adsorption specific area of less than 70 m²/g, there is a tendency that sufficient reinforcing ability and abrasion resistance cannot be easily obtained. When carbon black has nitrogen adsorption specific area of more than 300 m²/g, such carbon black is not preferable since there is a tendency that dispersability is decreased to increase heat build-up characteristic of the rubber composition. Examples of carbon black are HAF, ISAF and SAF, but not particularly limited thereto.

The amount of carbon black used in the present invention is at least 1 part by weight based on 100 parts of the rubber component. When the amount of. carbon black is less than 1 part by weight, reinforcing ability and abrasion resistance tend to decrease. When the amount is more than 150 parts by weight, not only dispersability is decreased but also desirable properties cannot be obtained. The lower limit of the amount of carbon black is 1 part by weight, preferably 5 parts by weight, more preferably 10 parts by weight, most preferably 15 parts by weight. The upper limit of the amount of carbon black is 150 parts by weight, preferably 120 parts by weight, more preferably 100 parts by weight, further preferably 85 parts by weight, particularly 70 parts by weight and most preferably 65 parts by weight.

In case where the rubber composition of the present invention comprises, for example, 5 to 150 parts by weight of calcium carbonate, at least 5 parts by weight of silica and at least 1 part by weight of carbon black based on 100 parts by weight of the rubber component, the total amount of calcium carbonate, silica and carbon black is preferably within the range of 50 to 150 parts by weight. When the total amount is less than 50 parts by weight, the effect of adding calcium carbonate to lower heat build-up characteristics tends to be insufficient. When the total amount is more than 150 parts by weight, dispersability tends to decrease. The upper limit of the total amount is more preferably 120 parts by weight, most preferably 100 parts by weight, and the lower limit of the total amount is more preferably 55 parts by weight, most preferably 60 parts by weight from the viewpoint of reinforcing ability and properties of the rubber composition.

Furthermore, in case where the rubber composition comprises, for example, 5 to 80 parts by weight of calcium carbonate, 5 to 100 parts by weight of silica and 5 to 145 parts by weight of carbon black based on 100 parts by weight of the rubber component, the total amount of silica and carbon black is preferably within the range of 50 to 150 parts by weight. When the total amount is less than 50 parts by weight, the effect of adding calcium carbonate to lower heat build-up characteristics tends to be insufficient. When the total amount is more than 150 parts by weight, dispersability tends to decrease. The upper limit of the total amount is more preferably 100 parts by weight, and the lower limit of the total amount is more preferably 55 parts by weight from the viewpoint of reinforcing ability and properties of the rubber composition.

The rubber composition of the present invention contains a silane coupling agent in order to enhance the bonding of fillers (calcium carbonate, silica and carbon black) to the rubber composition to improve abrasion resistance. For the silane coupling agent used in the present invention, it is possible to choose any conventional silane coupling agent which has been used in case of using silica as a filler.

Examples of silane coupling agents of the present invention are sulfide coupling agents such as bis(3-triethoxysilylpropyl)polysulfide, bis(2-triethoxysilylethyl)polysulfide, bis(3-trimethoxysilylpropyl) polysulfide, bis(2-trimethoxysilylethyl)polysulfide, bis(4-triethoxysilylbutyl)polysulfide and bis(4-trimethoxysilylbutyl) polysulfide, represented by the following formula (I):

(CₙH₂ₙ₊₁O)₃—Si—(CH₂)ₘ—Sₓ—(CH₂)ₘ—Si—(OCₙH₂ₙ₊₁)₃ (I)

wherein n is an integer of 1 to 3, m is an integer of 1 to 4 and x is the number of sulfur atoms in the polysulfide part, an average of x being 2.1 to 4, sulfide coupling agents such as 3-trimethoxysilylpropyl-N,N-dimethylthiocarbamoyltetrasulfide, 3-triethoxysilylpropyl-N,N-dimemthylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolytetrasulfide, 3-triethoxysilylpropylbenzothiazoltetrasulfide, 3-triethoxysilylpropylmethacrylatemonosulfide and 3-trimethoxysilylpropylmethacrylatemonosulfide; mercapto coupling agents such as 3-mercaptopropyltrimethoxysilane, 3-mercaptopropyltriethoxysilane, 2-mercaptoethyltrimethoxysilane and 2-mercaptoethyltriethoxysilane; vinyl coupling agents such as vinyltriethoxysilane and vinyltrimethoxysilane; amino coupling agents such as 3-aminopropyltriethoxysilane, 3-aminopropyltrimethoxysilane, 3-(2-aminoethyl)aminopropyltriethoxysilane, and 3-(2-aminoethyl) aminopropyltrimethoxysilane; glycidoxy coupling agents such as γ-glycidoxypropyltriethoxysilane, γ-glycidoxypropyltrimethoxysilane, γ-glycidoxypropylmethyldiethoxysilane and γ-glycidoxypropylmethyl dimethoxysilane; nitro coupling agents such as 3-nitropropyltrimethoxysilane and 3-nitoropropyltriethoxysilane; chloro coupling agents such as 3-chloropropyltrimethoxysilane, 3-chloropropyltriethoxysilane, 2-chloroethyltrimethoxysilane and 2-chloroethyltriethoxysilane; and the like. Among these, bis(3-triethoxysilylpropyl) polysulfide, 3-mercaptopropyltrimethoxysilane, 3-aminopropyltrimethoxysilane and vinyltriethoxysilane are suitably used from the viewpoint that the effect of adding the coupling agent is balanced with the costs.

More concrete examples of silane coupling agents represented by the formula (I) are bis(3-triethoxysilylpropyl)tetraslufide, bis(2-triethoxysilylethyl) tetraslufide, bis(3-trimethoxysilylpropyl) tetrasulfide, bis(2-trimethoxysilylethyl) tetraslufide, bis(3-triethoxysilylpropyl) trisulfide, bis(3-trimethoxysilylpropyl)trisulfide, bis(3-triethoxysilylpropyl)disulfde and bis(3-trimethoxysilylpropyl) disulfide. Among these, bis(3-triethoxysilylpropyl) tetrasulfide is suitably used from the viewpoint that the effect of adding the coupling agent is balanced with the costs.

The silane coupling agent may be used alone or in combination of two or more.

The amount of the silane coupling agent is preferably 1 to 20% by weight based on the total amount of calcium carbonate and silica. When the amount of the silane coupling agent is less than 1% by weight, the effect of adding the silane coupling agent tends to be insufficient. When the amount of the silane coupling agent is more than 20% by weight, the coupling effect cannot be obtained though costs are increased, and reinforcing ability as well as abrasion resistance tend to decrease. From the viewpoint of dispersiability and coupling effect, the lower limit of the amount of the silane coupling agent is preferably 2% by weight and the upper limit thereof is preferably 15% by weight.

In case where the rubber composition of the present invention contains a polyether compound, the amount of the silane coupling agent is preferably 1 to 20% by weight based on the weight of silica. When the amount of the silane coupling agent is less than 1% by weight, the effect of adding the silane coupling agent tends to be insufficient. Again, when the amount of the silane coupling agent is more than 20% by weight, the coupling effect cannot be obtained though costs are increased, and reinforcing ability as well as abrasion resistance tend to decrease. From the viewpoint of dispersiability and coupling effect, the lower limit of the amount of the silane coupling agent is preferably 2% by weight and the upper limit thereof is preferably 15% by weight.

The polyether compound to be used in the present invention comprises repeating units represented by the following formula (II):

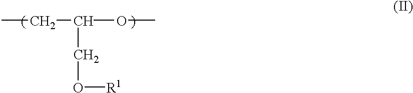

wherein R¹ is a hydrogen atom or a substituent selected from the group consisting of a hydrocarbon group having 1 to 50 carbon atoms, a siloxy silyl propyl group having 1 to 50 silicon atoms and a group represented by the formula —(AO)ₘ—R², and R¹ may be one kind or different kinds; and in the formula, R² is a hydrogen atom or a substituent selected from the group consisting of a hydrocarbon group having 1 to 42 carbon atoms and a siloxy silyl propyl group having 1 to 40 silicon atoms, A is an alkylene group having 2 to 3 carbon atoms, m is an integer of 1 to 100 and A, the number of which is represented by m, may be the same or different.

When R¹ in the formula (II) is a hydrocarbon group, preferable examples of R¹ are an alkyl group or an alkenyl group having 1 to 42 carbon atoms, an aryl group having 6 to 42 carbon atoms, or an aryl alkyl group or alkyl aryl group having 7 to 43 carbon atoms. More preferable examples thereof are an alkyl group having 1 to 30 carbon atoms, such as methyl group, ethyl group, n-propyl group, isopropyl group, n-butyl group, t-butyl group, octyl group, decyl group, dodecyl group, cetyl group or stearyl group; an alkenyl group having 2 to 30 carbon atoms such as allyl group; an aryl group having 6 to 30 carbon atoms such as phenyl group; an alkyl aryl group having 7 to 31 carbon atoms such as nonyl phenyl group; and the like. When R¹ contains too many carbon atoms, dispersion effect and surface modification effect on calcium carbonate tend to decrease.

When R¹ is a siloxy silyl propyl group, preferable examples of R¹ are a linear or branched siloxy silyl propyl group having 1 to 30, particularly 1 to 20 silicon atoms. The alkyl substituent which binds to silicon atoms of the siloxy silyl propyl group may be the same or different, and examples thereof are methyl group, butyl group, vinyl group, phenyl group and the like.

In the above formula (II), R¹ may have a substituent, and examples thereof are hydroxy group, alkoxy group (having 1 to 30 carbon atoms), amino group, dimethyl amino group, diethyl amino group, amido group (having 1 to 18 carbon atoms), trialkyl ammonium group (whose alkyl group has 1 to 30 carbon atoms), dialkyl ammonium group (whose alkyl group has 1 to 30 carbon atoms), alkyl ammonium group (whose alkyl group has 1 to 30 carbon atoms), ammonium group, methyl ester group, ethyl ester group, carboxyl group, acyl group (having 1 to 18 carbon atoms), silyl group, siloxy group and the like (hereinafter referred to as “substituents of the present invention”).

When R¹ is a group represented by the formula —(AO)ₘ—R² and R² is a hydrocarbon group, preferable examples of R² are methyl group, ethyl group, n-butyl group, t-butyl group, octyl group, decyl group, dodecyl group, cetyl group, stearyl group, phenyl group, nonyl phenyl group and the like.

When R² is a siloxy silyl propyl group, preferable examples of R² are a siloxy silyl propyl group having 1 to 20 silicon atoms. The alkyl substituent which binds to silicon atoms of the siloxy silyl propyl group may be the same or different, and examples thereof are methyl group, butyl group, vinyl group, phenyl group and the like.

R² may have a substituent, and examples thereof are the substituents of the present invention.

Furthermore, examples of A are ethylene group and propylene group. Preferably, m is an integer of 1 to 50, more preferably an integer of 5 to 10.

The polyether compound (II) of the present invention is obtained by polymerizing an epoxy compound represented by the formula (III) alone or co-polymerizing the epoxy compound with another monomer (X). That is, the polyether compound (III) is obtained by either of the following reaction formulae:

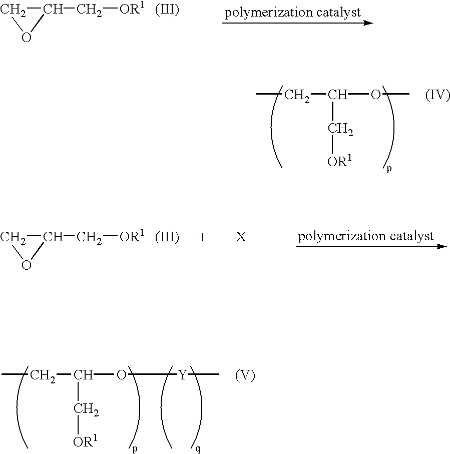

wherein R¹ is as defined above, X represents another monomer copolymerizable with substituted epoxide (III), Y represents a polymerization unit derived from the monomer X and p and q represent repeating of each polymerization unit.

In these cases, p is preferably 5 to 2,000,000. When p is less than 5, covering ability for calcium carbonate tends to be decreased. When p is more than 2,000,000, dispersability of the polyether compound itself is decreased and therefore its surface modification effect on calcium carbonate tends to decrease. More preferably, the lower limit of p is 10 and the upper limit of p is 1,000,000, particularly 100,000. In case of using X, q is not 0, and preferably 1 to 100,000.

In the polyether compounds (IV) and (V), R¹ may be different kinds. In that case, sequence thereof in the polyether main chain may be any of block sequence, alternate sequence or random sequence. The sequence of the polymerization unit Y in the compound (VI) may also be any of block sequence, alternate sequence or random sequence.

Examples of monomer X are an ethylene oxide, a substituted epoxide other than the substituted epoxide (III) or an anionic polymerizable monomer other than epoxides. Preferable examples thereof are ethylene oxide, propylene oxide, alkylene oxide having 4 to 22 carbon atoms, 3-perfluoroalkyl-1,2-epoxypropane, lactones with four rings, six rings or seven rings, carbonates with five rings or six rings, lactams, hexamethylcyclotrisiloxane, octamethylcyclotetrasiloxane, (meth)acrylic acid esters such as methyl (meth)acrylate, styrene, butadiene, isoprene, end olefins having 5 to 22 carbon atoms and the like.

The amount of the polyether compound used in the present invention is preferably 0.1 to 150% by weight based on the weight of calcium carbonate. When the amount of the polyether compound is less than 0.1% by weight, there is a tendency that sufficient dispersion effect cannot be obtained. When the amount is more than 150% by weight, there is a tendency that dispersion effect cannot be obtained though the costs are increased. The lower limit of the amount of the polyether compound is more preferably 0.5% by weight. The upper limit of the amount of the polyether compound is more preferably 100% by weight, most preferably 80% by weight.

The polyether compound of the present invention may be used alone or in combination of two or more. Additionally, it is possible to use known surface modifiers, dispersion agents, surfactants or coupling agents at the same time.

It is preferable that the rubber composition of the present invention is obtained by kneading the above mentioned rubber component, calcium carbonate, silica, carbon black and silane coupling agent simultaneously at kneading temperature of 120° to 200° C. in a mixing step. When the kneading temperature is lower than 120° C., reactivity of the silane coupling agent is low and there is a tendency that sufficient properties cannot be achieved. When the kneading temperature is more than 200° C., the rubber tends to be burned. The lower limit of the kneading temperature is more preferably 140° C. and the upper limit of the kneading temperature is more preferably 180° C.

In the above mixing step, kneading time may be adjusted to 3 to 15 minutes. When the kneading time is shorter than 3 minutes, dispersion of calcium carbonate, silica and carbon black tends to be insufficient. When the kneading time is longer than 15 minutes, the molecular weight of the rubber component tends to decrease.

The pneumatic tire of the present invention is prepared by a normal process using the rubber composition of the present invention for the tread part. That is, the rubber composition is extruded and processed so that it matches with shapes of each tire part without vulcanization; the processed composition is then formed into tread on a tire forming machine in a usual manner to obtain an unvulcanized tire; and the unvulcanized tire is press-heated in a vulcanizing machine to prepare a tire.

Further, inorganic compound powder and any agents such as softeners, antioxidants, vulcanizing agents, vulcanization accelerators and auxiliary vulcanization activators which are used in the normal rubber industry may be suitably added, if necessary, to the rubber composition of the present invention in addition to the above rubber component, carbon black, silica, silane coupling agent, calcium carbonate and polyether compound.

However, it is preferable to compound vulcanizing agents and vulcanization accelerators and knead the components together, after the kneading of other components.

The rubber composition of the present invention enables to improve low heat build-up characteristics and wet grip performance without lowering processability and abrasion resistance, and can be suitably used for tire tread.

The present invention is explained in detail based on Examples below, but not limited thereto.

Materials used in Examples and Comparative Examples are listed below.

### Chemicals

SBR: SBR 1502 (a styrene-butadiene copolymer) available from JSR Corporation

Calcium carbonate: Hakuenka CC available from SHIRAISHI KOGYO KAISHA LTD. (treated with fatty acid; nitrogen adsorption specific area: 26 m²/g; average particle diameter: 0.04 μm)

Carbon black: SHOBLACK N220 (nitrogen adsorption specific area: 125 m²/g) available from Showa Cabot Co. Ltd.

Silica: Ultrasil VN 3 available from Degussa Co. (nitrogen adsorption specific area: 210 m²/g)

Silane coupling agent: Si69 (bis(3-triethoxysilylpropyl)tetrasulfide) available from Degussa Co.

Aromatic oil: JOMO Process X140 available from Japan Energy Corporation

Antioxidant: Nocluc 6C (N-(1,3-dimethyl butyl)-N′-phenyl-p-phenylenediamine) available from Ohuchi Shinko Kagaku Kogyo Co.

Ltd.

Stearic acid: stearic acid available from NOF Corporation

Zinc oxide: zinc oxide No. 1 available from Mitsui Mining and Smelting Co., Ltd.

Sulfur: powdery sulfur available from Tsurumi Chemicals Co., Ltd.

Vulcanization accelerator TBBS: Nocceler NS (N-tert-butyl-2-benzothiazylsulfenamide) available from Ohuchi Shinko Kagaku Kogyo Co. Ltd.

Vulcanization accelerator DPG: Nocceler D (N,N′-diphenylguanidine) available from Ohuchi Shinko Kagaku Kogyo Co. Ltd.

### EMBODIMENT 1

### EXAMPLES 1 to 3 and COMPARATIVE EXAMPLES 1 to 3

Components in Table 1 other than sulfur, vulcanization accelerator TBBS and vulcanization accelerator DPG were kneaded at 150° C. for 4 minutes. Then sulfur, TBBS and DPG were added thereto and the mixture was kneaded at roll temperature of 20° C. for 5 minutes to obtain samples of the rubber composition. The compounds were press-vulcanized at 170° C. for 20 minutes to obtain vulcanized materials. Each of the obtained samples was subjected to the following property tests.

### Tests

### Abrasion Test

Using a Lambourne abrasion tester, the Lambourne abrasion amount was measured at 20° C. under a load of 2.5 kgf and a slip ratio of 20% for 5 minutes, and volume loss values of each compound were calculated. The calculated value was represented as an index to the loss value of Comparative Example 1 as 100 according to the following equation. The larger the index is, the more excellent the abrasion resistance is.

(abrasion index)=(loss value of Comparative Example 1) ÷(loss value of each compound)×100

### Rolling Resistance Index

The loss tangent (tan δ) of each compound was measured by using a viscoelasticity spectrometer VES (made by Iwamoto Corporation) at 70° C. under initial strain of 10% and dynamic strain of 2%. The loss tangent value of each compound was represented as an index to the tan δ value of Comparative Example 1 as 100 according to the following equation. The larger the index is, the more excellent the rolling resistance property is and the lower heat build-up characteristic is.

(rolling resistance index)=(tan δ of Comparative Example 1)÷(tan δ of each compound)×100

### Wet Skid Test

The wet skid resistance was measured according to the method of ASTM E303-83 using a portable skid tester made by Stanley Inc. The wet skid resistance value was represented as an index to the measured value of Comparative Example 1 as 100 according to the following equation. The larger the index is, the more excellent the wet skid performance is.

(wet skid index)=(wet skid resistance of each compound)÷(wet skid resistance of Comparative Example 1)×100

The results are shown in Table 1. Wet skid performance was improved without lowering of abrasion resistance and rolling resistance property in case of Examples 1 to 3 where all of carbon black, calciumcarbonate, silica and silane coupling agent are compounded to SBR in particular amounts.

TABLE 1

| | Ex. No. | | | Com. Ex. No. | | |
|---|---|---|---|---|---|---|
| | 1 | 2 | 3 | 1 | 2 | 3 |
| Compound (part by weight) | | | | | | |
| SBR1502 | 100 | 100 | 100 | 100 | 100 | 100 |
| Calcium carbonate | 5 | 15 | 30 | — | — | — |
| Silica | 30 | 20 | 20 | 60 | — | 30 |
| Carbon black | 25 | 25 | 25 | — | 60 | 30 |
| Si 69 | 3.5 | 3.5 | 5 | 6 | — | 3 |
| Aromatic oil | 8 | 8 | 8 | 20 | 20 | 20 |
| Antioxidant | 1 | 1 | 1 | 1 | 1 | 1 |
| Stearic acid | 2 | 2 | 2 | 2 | 2 | 2 |
| Zinc oxide | 3 | 3 | 3 | 3 | 3 | 3 |
| Sulfur | 1.5 | 1.5 | 1.5 | 1.5 | 1.5 | 1.5 |
| Vulcanization Accelerator | 1 | 1 | 1 | 1 | 1 | 1 |
| TBBS | | | | | | |
| Vulcanization Accelerator | 0.5 | 0.5 | 0.5 | 0.5 | 0.5 | 0.5 |
| DPG | | | | | | |
| Properties | | | | | | |
| Abrasion resistance index | 105 | 106 | 103 | 100 | 112 | 105 |
| Rolling resistance index | 102 | 104 | 108 | 100 | 90 | 95 |
| Wet skid index | 105 | 108 | 112 | 100 | 85 | 91 |

### EMBODIMENT 2

### EXAMPLES 4 to 6 and COMPARATIVE EXAMPLES 4 to 7

Components in Table 2 other than sulfur and vulcanization accelerator TBBS and vulcanization accelerator DPG were kneaded at 150° C. for 4 minutes. Then, sulfur, TBBS and DPG were added thereto and the mixture was kneaded at roll temperature of 20° C. for 5 minutes to obtain samples of the rubber composition. The compounds were press-vulcanized at 170° C. for 20 minutes to obtain vulcanized materials. Each of the obtained samples was subjected to the following property tests.

### Tests

### Abrasion Test

Evaluation was made in the same manner as in Embodiment 1 except that the loss value of Comparative Example 4 was assumed to be 100.

### Rolling Resistance Index

Evaluation was made in the same manner as in Embodiment 1 except that the tan δ value of Comparative Example 4 was assumed to be 100.

### Wet Skid Test

Evaluation was made in the same manner as in Embodiment 1 except that the measured value of Comparative Example 4 was assumed to be 100.

The results are shown in Table 2. Wet skid performance was improved without lowering of abrasion resistance and rolling resistance property in case of Examples 4 to 6 where all of carbon black, calciumcarbonate, silica and silane coupling agent are compounded to SBR in particular amounts.

TABLE 2

| | Ex. No. | | | Com. Ex. No. | | | |
|---|---|---|---|---|---|---|---|
| | 4 | 5 | 6 | 4 | 5 | 6 | 7 |
| Compound | | | | | | | |
| (part by weight) | | | | | | | |
| SBR1502 | 100 | 100 | 100 | 100 | 100 | 100 | 100 |
| Calcium carbonate | 20 | 20 | 20 | — | — | 20 | 20 |
| Silica | 10 | 15 | 5 | — | 60 | — | — |
| Carbon black | 40 | 40 | 40 | 60 | — | 40 | 40 |
| Si 69 | 2.4 | 2.8 | 2 | — | 6 | — | 1.6 |
| Aromatic oil | 8 | 8 | 8 | 15 | 15 | 15 | 8 |
| Antioxidant | 1 | 1 | 1 | 1 | 1 | 1 | 1 |
| Stearic acid | 2 | 2 | 2 | 2 | 2 | 2 | 2 |
| Zinc oxide | 3 | 3 | 3 | 3 | 3 | 3 | 3 |
| Sulfur | 1.5 | 1.5 | 1.5 | 1.5 | 1.5 | 1.5 | 1.5 |
| Vulcanization | 1 | 1 | 1 | 1 | 1 | 1 | 1 |
| Accelerator TBBS | | | | | | | |
| Vulcanization | 0.5 | 0.5 | 0.5 | 0.5 | 0.5 | 0.5 | 0.5 |
| Accelerator DPG | | | | | | | |
| Properties | | | | | | | |
| Abrasion resistance | 103 | 104 | 102 | 100 | 90 | 96 | 100 |
| index | | | | | | | |
| Rolling resistance | 109 | 112 | 107 | 100 | 110 | 102 | 105 |
| index | | | | | | | |
| Wet skid index | 105 | 107 | 103 | 100 | 115 | 100 | 102 |

### EMBODIMENT 3

Polyether compounds were synthesized according to the following Preparation Examples. The molecular weight of the synthesized polyether compounds was measured according to GPC using a measuring machine type 150C made by Waters Inc. and two columns Shodex HT-806 and Shodex HT-803 available from Showa Denko K.K. (column temperature: 130° C., moving phase: o-dichlorobenzene). The molecular weight of the synthesized polyether compound was determined as the number average molecular weight (hereinafter referred to as Mn) converted to a polystyrene basis.

### PREPARATION EXAMPLE 1

### Polyether Compound 1

In toluene, 50 g of stearyl glycidyl ether was polymerized at 130° C. for 12 hours by using samarium alkoxide-methyl almoxane catalyst in an amount of 1% by mole (based on glycidyl ether, and so forth). The reaction mixture was purified by reprecipitation and white solid polyether compound 1 was obtained. The obtained compound was a modifying agent having a higher alkyl group in the side chain. The compound had a Mn of 290,000. The structure of the compound is shown below:

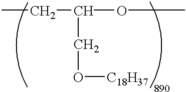

### PREPARATION EXAMPLE 2

### Polyether Compound 2

Light yellow solid polyether compound 2 was obtained in the same manner as in Preparation Example 1 except for using 40 g of stearyl glycidyl ether and 10 g of phenyl glycidyl ether instead of 50 g of stearyl glycidyl ether. The obtained compound was a modifying agent having a higher alkyl group and a phenyl group in the side chain. The compound had a Mn of 270,000. The structure of the compound is shown below:

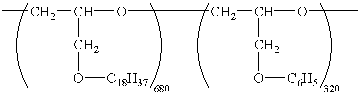

### PREPARATION EXAMPLE 3

### Polyether Compound 3

White solid polyether compound 3 was obtained in the same manner as in Preparation Example 1 except for using 40 g of stearyl glycidyl ether and 10 g of allyl glycidyl ether instead of 50 g of stearyl glycidyl ether. The obtained compound was a modifying agent having a higher alkyl group and an allyl group in the side chain. The compound had a Mn of 260,000. The structure of the compound is shown below:

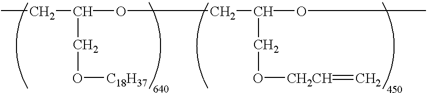

### PREPARATION EXAMPLE 4

### Polyether Compound 4

A colorless and transparent soft polymer, i.e., polyether compound 4 was obtained in the same manner as in Preparation Example 1 except for using 40 g of n-butyl glycidyl ether and 10 g of allyl glycidyl ether instead of 50 g of stearyl glycidyl ether. The obtained compound was a modifying agent having a butyl group and an allyl group in the side chain. The compound had a Mn of 130,000. The structure of the compound is shown below:

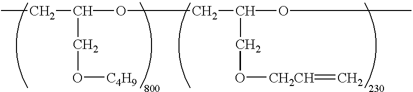

### EXAMPLES 7 to 11 and COMPARATIVE EXAMPLES 8 to 12

Components in Table 3 other than sulfur and vulcanization accelerator TBBS and vulcanization accelerator DPG were kneaded at 150° C. for 4 minutes. Then, sulfur, TBBS and DPG were added thereto and the mixture was kneaded at roll temperature of 20° C. for 5 minutes to obtain samples of the rubber composition. The compounds were press-vulcanized at 170° C. for 20 minutes to obtain vulcanized materials. Each of the obtained samples was subjected to the following property tests.

### Tests

### Abrasion Test

Evaluation was made in the same manner as in Embodiment 1 except that the loss value of Comparative Example 8 was assumed to be 100.

### Rolling Resistance Index

Evaluation was made in the same manner as in Embodiment 1 except that the tan δ value of Comparative Example 8 was assumed to be 100.

### Wet Skid Test

Evaluation was made in the same manner as in Embodiment 1 except that the measured value of Comparative Example 8 was assumed to be 100.

The results are shown in Tables 3. It is found that the rubber composition of Comparative Example 9 obtained by compounding silica instead of part of carbon black together with a silane coupling agent has inferior reinforcing ability and decreased abrasion resistance though low heat build-up characteristics and grip performance thereof are improved.

It is found that the rubber composition of Comparative Example 10 obtained by compounding calcium carbonate instead of part of carbon black; the rubber composition of Comparative Example 11 obtained by compounding calcium carbonate instead of part of carbon black together with a silane coupling agent; and the rubber composition of Comparative Example 12 obtained by compounding calcium carbonate instead of part of carbon black together with a polyether compound have inferior reinforcing ability and decreased abrasion resistance as well, though low heat build-up characteristics and grip performance thereof are improved.

On the other hand, as to the rubber compositions of Examples 7 to 10 obtained by compounding silica and calcium carbonate instead of part of carbon black together with a silane coupling agent and a polyether compound, improvement of low heat build-up characteristics and grip performance was achieved without lowering abrasion resistance.

TABLE 3

| | Ex. No. | | | | | Com. Ex. No. | | | | |
|---|---|---|---|---|---|---|---|---|---|---|
| | 7 | 8 | 9 | 10 | 11 | 8 | 9 | 10 | 11 | 12 |
| Compound (part by weight) | | | | | | | | | | |
| SBR1502 | 100 | 100 | 100 | 100 | 100 | 100 | 100 | 100 | 100 | 100 |
| Calcium carbonate | 20 | 20 | 20 | 20 | 20 | — | — | 20 | 20 | 20 |
| Silica | 10 | 10 | 10 | 10 | 10 | — | 20 | — | — | — |
| Carbon black | 30 | 30 | 30 | 30 | 30 | 60 | 40 | 40 | 40 | 40 |
| Si 69 | 1 | 1 | 1 | 1 | 1 | — | 2 | — | 2 | — |
| Polyether compound 1 | 0.5 | — | — | — | — | — | — | — | — | — |
| Polyether compound 2 | — | 0.5 | — | — | — | — | — | — | — | 0.5 |
| Polyether compound 3 | — | — | 0.5 | — | — | — | — | — | — | — |
| Polyether compound 4 | — | — | — | 0.5 | — | — | — | — | — | — |
| Aromatic oil | 8 | 8 | 8 | 8 | 8 | 15 | 15 | 8 | 8 | 8 |
| Antioxidant | 1 | 1 | 1 | 1 | 1 | 1 | 1 | 1 | 1 | 1 |
| Stearic acid | 2 | 2 | 2 | 2 | 2 | 2 | 2 | 2 | 2 | 2 |
| Zinc oxide | 3 | 3 | 3 | 3 | 3 | 3 | 3 | 3 | 3 | 3 |
| Sulfur | 1.5 | 1.5 | 1.5 | 1.5 | 1.5 | 1.5 | 1.5 | 1.5 | 1.5 | 1.5 |
| Vulcanization Accelerator TBBS | 1 | 1 | 1 | 1 | 1 | 1 | 1 | 1 | 1 | 1 |
| Vulcanization Accelerator DPG | 0.5 | 0.5 | 0.5 | 0.5 | 0.5 | 0.5 | 0.5 | 0.5 | 0.5 | 0.5 |
| Properties | | | | | | | | | | |
| Abrasion resistance index | 100 | 102 | 100 | 101 | 93 | 100 | 96 | 85 | 89 | 86 |
| Rolling resistance index | 115 | 118 | 114 | 116 | 113 | 100 | 108 | 111 | 113 | 111 |
| Wet skid index | 107 | 109 | 107 | 108 | 107 | 100 | 103 | 104 | 105 | 106 |

The rubber composition of the present invention retains low heat build-up characteristics without lowering of abrasion resistance, and has excellent wet grip performance at the same time. Accordingly, the rubber composition is useful as a rubber composition for tire tread. The pneumatic tire of the present invention is obtained by using the above rubber composition for the tread part. Accordingly, the tire has excellent abrasion resistance, low heat build-up characteristics and wet grip performance.

According to the present invention, low heat build-up characteristics and wet grip performance can be improved without lowering of processability and abrasion resistance by using carbon black, silica and calcium carbonate as a filler for the rubber composition together with a silane coupling agent.

According to the present invention, low heat build-up characteristics and wet grip performance can be significantly improved without lowering of processability and abrasion resistance by using a particular polyether compound as a filler for the rubber composition in addition to the above components (i.e. carbon black, silica, calcium carbonate and silane coupling agent).

What is claimed is

1. A rubber composition for tire tread comprising,
5 to 150 parts by weight of calcium carbonate,
at least 5 parts by weight of silica having nitrogen adsorption specific surface area of 100 to 300 m²/g, and
at least 1 part by weight of carbon black having nitrogen adsorption specific surface area of 70 to 300 m²/g,
based on 100 parts by weight of a rubber component,
said rubber composition further comprising a silane coupling agent.

2. The rubber composition for tire tread of claim 1, wherein the total amount of calcium carbonate, silica and carbon black is 50 to 150 parts by weight.

3. The rubber composition for tire tread of claim 1, wherein calcium carbonate has nitrogen adsorption specific surface area of at least 5 m²/g.

4. The rubber composition for tire tread of claim 1, wherein calcium carbonate has an average particle diameter of 0.01 to 50 μm.

5. The rubber composition for tire tread of claim 1, wherein the silane coupling agent is used in an amount of 1 to 20% by weight based on the weight of calcium carbonate and silica.

6. The rubber composition for tire tread of claim 1, wherein the silane coupling agent is a silane coupling agent represented by the following formula (I):
(CₙH₂ₙ₊₁O)_{3—Si—(CH}₂)ₘ—Sₓ—(CH₂)ₘ—Si—(OCₙH₂ₙ₊₁)₃ (I)
wherein n is an integer of 1 to 3, m is an integer of 1 to 4 and x is the number of sulfur atoms in the polysulfide part, and an average of x is 2.1 to 4.

7. The rubber composition for tire tread of claim 1, further comprising, based on the weight of calcium carbonate, 0.1 to 150% by weight of a polyether compound having a repeating unit represented by the following formula (II): 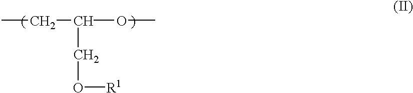
wherein R¹ is a hydrogen atom or a substituent selected from the group consisting of a hydrocarbon group having 1 to 50 carbon atoms, a siloxy silyl propyl group having 1 to 50 silicon atoms and a group represented by the formula —(AO)ₘ—R², and R¹ may be one kind or different kinds; and in the formula, R² is a hydrogen atom or a substituent selected from the group consisting of a hydrocarbon group having 1 to 42 carbon atoms and a siloxy silyl propyl group having 1 to 40 silicon atoms, A is an alkylene group having 2 to 3 carbon atoms, m is an integer of 1 to 100 and A, the number of which is represented by m, may be the same or different.

8. The rubber composition for tire tread of claim 1 obtained by kneading the rubber component, calcium carbonate, silica, carbon black and silane coupling agent simultaneously at kneading temperature of 120° to 200° C.

9. A pneumatic tire obtained by using the rubber composition of claim 1 for tire tread.
